(19) United States
(12) Patent Application Publication
(10) Pub. No.: US 2003/0142591 A1
(43) Pub. Date: Jul. 31, 2003

(54) Interactive alarm clock and method

(75) Inventors: Baljeet Singh Baweja, Austin, TX (US); Kulvir Singh Bhogal, Fort Worth, TX (US); Nizamudeen Ishmael JR., Austin, TX (US); Mandeep Singh Sidhu, Pflugerville, TX (US)

Correspondence Address: HOFFMAN WARNICK & D'ALESSANDRO, LLC, 3 E-COMM SQUARE, ALBANY, NY, 12207

(73) Assignee: INTERNATIONAL BUSINESS MACHINES CORPORATION, ARMONK, NY

(21) Appl. No.: 10/062,365

(22) Filed: Jan. 31, 2002

(51) Int. Cl. G04C 21/16; G04B 23/02; G04B 23/00

(52) U.S. Cl. 368/263; 368/245

(57) ABSTRACT

An interactive alarm clock and method are provided. Specifically, the alarm clock of the present invention is programmable by a user so that distinct alarm signals can be designated. In a typical embodiment, distinct alarm signals are designated based upon volume level, alarm type and/or alarm signal harmonics. For example, a first alarm signal could be produced at a first designated volume level. If the first alarm signal is snoozed, a second alarm signal would later be produced at a second (e.g., higher) designated volume level.

### BACKGROUND OF THE INVENTION

1. Field of the Invention

The present invention generally relates to an interactive alarm clock and method. More particularly, the present invention relates to an interactive alarm clock in which a user can designate distinct alarm signals so that a different alarm signal is produced with each activation of a snooze mechanism.

2. Background Art

Each year, a large number of people either miss work or report late due to their inability to awake to their alarm clocks. Specifically, many individuals have either become immune to the sounds of their alarm clocks, or have become accustomed to activating the snooze mechanism multiple times. In either case, the concept of waking up to an alarm clock has become fruitless.

Some alarm clocks attempt to prevent this by providing a separate volume knob for the alarm. The separate volume knob allows the user to listen to the radio at one volume level and hear an alarm signal at another volume level. Such a feature, however, fails to allow a user to designate distinct individual alarm signals. Rather, all alarm signals will have the same volume and may still fail to awake the user who has become immune to the alarm volume or accustomed to activating the snooze mechanism.

Other alarm clocks attempt to alleviate these problems by providing increasing alarm signal volume. However, no such clock allows a user to program distinct volume levels for separate alarm signals. In contrast, the alarm signal volume increase is preprogrammed and is the same for all alarm signals. Thus, the user can still become immune to the volume.

A further problem with existing alarm clocks is the failure of the alarm feature to be disengaged when the user is not present. Specifically, a user may travel for an extended period of time. If the user neglected to disengage the alarm clock during this period, the alarm may continue to sound daily as programmed. The could be extremely disruptive to others who are forced to hear the alarm signal everyday.

In view of the foregoing, there exists a need for an interactive alarm clock in which the user can designate distinct alarm signals based upon volume level, alarm type and/or alarm signal harmonics so that each time a snooze mechanism is activated, a distinct alarm signal will be produced. A need also exists for an interactive alarm clock in which the snooze time between alarm signals can be designated. Another need exists for an interactive alarm clock in which a maximum snooze quantity can be designated. A further need exists for an interactive alarm clock that includes a motion detector so that the alarm clock can be disengaged when no motion is detected proximate the alarm clock during a designated period.

### SUMMARY OF THE INVENTION

The present invention overcomes the drawbacks of existing devices by providing an interactive alarm clock and method. Specifically, under the present invention, a user can designate distinct alarm signals. In a typical embodiment, the user will designate distinct alarm signals based upon volume level. Each time the snooze mechanism of the alarm clock is activated, a current alarm signal will be deactivated and a new alarm signal will be activated, after a predetermined time. Each alarm signal will have the volume level designated therefor. Thus, the user can program the alarm clock to produce alarm signals of differing volume with each activation of the snooze mechanism. The alarm clock of the present invention also allows the user to program, among other things: (1) the time between alarm signals when the snooze mechanism is activated; (2) a maximum number of snoozes; (3) an alarm type (e.g., buzzer, audio, etc.) for each alarm signal; (4) alarm signal harmonics (e.g., pitch, frequency, etc.); and (5) and a motion detection period for disengaging the alarm clock if no motion is detected during the designated period.

According to a first aspect of the present invention, an interactive alarm clock is provided. The alarm clock comprises: (1) a system for designating distinct alarm signals; and (2) a snooze mechanism for deactivating a first designated alarm signal and automatically activating a second designated alarm signal after a predetermined time.

According to a second aspect of the present invention, an interactive alarm clock is provided. The alarm clock comprises: (1) a volume system for designating distinct volume levels for successive alarm signals; and (2) a snooze mechanism for deactivating a first alarm signal having a first designated volume level and automatically activating a second alarm signal having a second designated volume level after a predetermined time.

According to a third aspect of the present invention, a method for operating an alarm clock is provided. The method comprises: (1) designating distinct alarm signals; and (2) deactivating a first designated alarm signal and automatically activating a second designated alarm signal after a predetermined time.

According to a fourth aspect of the present invention, a program product stored on a recordable medium for operating an alarm clock is provided. The program product, comprises: (1) program code for designating distinct alarm signals; and (2) program code for deactivating a first designated alarm signal and automatically activating a second designated alarm signal after a predetermined time.

Therefore, the present invention provides an interactive alarm clock and method.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an interactive alarm clock having a program system according to the present invention.

FIG. 2 depicts a logic flowchart according to one embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a user-programmable interactive alarm clock. Specifically, the alarm clock allows a user to designate distinct alarm signals so that successive alarm signals can be different from one another. Thus, each time a snooze mechanism of the alarm clock is activated, the subsequent alarm signal can have a volume level, alarm type and/or alarm signal harmonics that is distinct from the preceding alarm signal. This prevents the user from becoming immune to a single alarm signal. In addition, the present invention allows the user to designate, among other things, the time between alarm signals upon activating the snooze mechanism, a maximum number of times the snooze feature of the clock can be used, and a motion detection period for disengaging the alarm clock.

It should be appreciated that, as will be further described below, the present invention can be realized as a standard alarm clock or as a computer-based alarm clock. In the case of the former, the alarm clock can be programmed locally as known in the art (e.g., via knobs, buttons, dials, etc.). In the case of the latter, the alarm clock can be programmed locally (e.g., using knobs, buttons, dials, input devices, touch screen, etc.), or remotely through an interface (e.g., via the Internet)

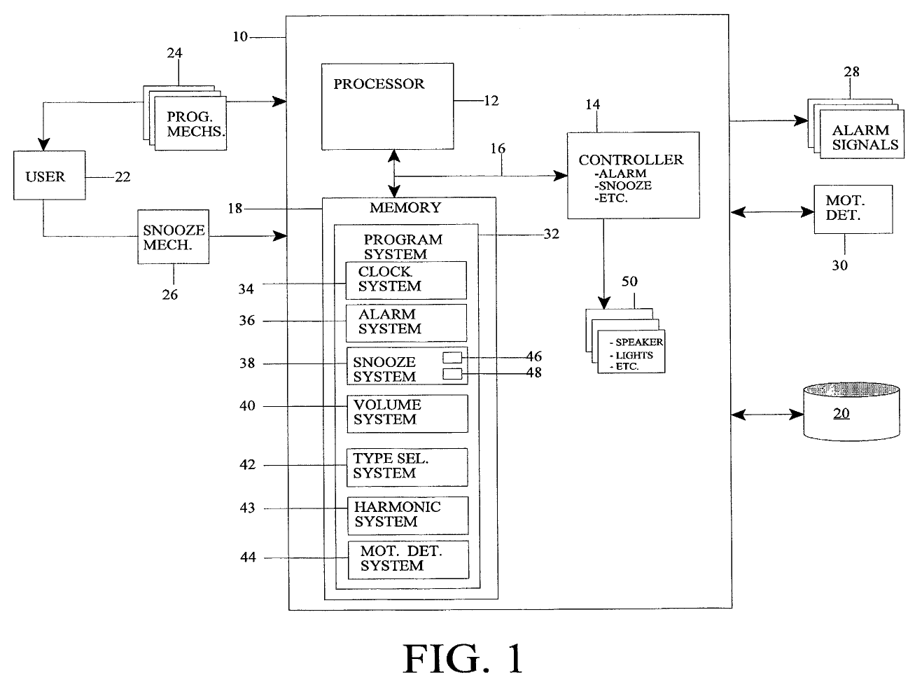

Referring now to FIG. 1, an alarm clock 10 according to the present invention is shown. As indicated above, alarm clock 10 could be a standard alarm clock or a computer-based alarm clock. As depicted, alarm clock 10 generally comprises processor 12, controller 14, bus 16, memory 18, and database 20. Memory 18 may comprise any known type of data storage and/or transmission media, including magnetic media, optical media, random access memory (RAM), read-only memory (ROM), a data cache, a data object, etc. Moreover, memory 18 may reside at a single physical location, comprising one or more types of data storage, or be distributed across a plurality of physical systems in various forms. Processor 12 may likewise comprise a single processing unit, or be distributed across one or more processing units in one or more locations, e.g., on a client and server. Bus 16 provides a communication link between each of the components in the alarm clock 10 and likewise may comprise any known type of transmission link, including electrical, optical, wireless, etc. Controller 14 will be described in further detail below, but generally works in conjunction with program system 32 to control the various features of alarm clock 10 such as the alarm and snooze features. In addition, additional components 50, such as cache memory, input/output (I/O) interfaces, communication systems, system software, a radio, a speaker, a light array/display, compact disk player, etc., may be incorporated into alarm clock 10.

Database 20 could provide storage for information necessary to carry out the present invention. Such information could include, among other things, (1) designated volume levels; (2) designated alarm types; (3) designated alarm signal harmonics; (4) a designated time between alarm signals 28 (i.e., snooze time); (5) a designated limit on the quantity of snoozes; and (6) a designated motion detection period for disengaging alarm clock 10. Database 20 may include one or more storage devices, such as a magnetic disk drive or an optical disk drive. In another embodiment database 20 includes data distributed across, for example, a local area network (LAN), wide area network (WAN) or a storage area network (SAN) (not shown). Database 20 may also be configured in such a way that one of ordinary skill in the art may interpret it to include one or more storage devices.

Stored in memory 18 and executable by processor 16 is program system 32. Program system 32 includes various systems for programming alarm clock 10 by manipulating program mechanisms 24. Since alarm clock 10 can be a standard or computer-based alarm clock, program mechanisms 24 could be knobs, buttons and/or dials, external input devices such as a mouse keyboard or a touch screen, or any combination thereof. Moreover, if alarm clock 10 is computer-based, user 22 could program from a remote location via the Internet. In this case, program mechanisms 24 would include an interface and user could be connected to alarm clock 10 with a direct terminal, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

Under the present invention, user 22 can program alarm clock 10 to have distinct alarm signals 28. Specifically, alarm clock 10 of the present invention can be programmed by user 22 to produce a distinct alarm signal 28 every time snooze mechanism 26 (i.e., a snooze button) is activated (also referred as “snoozing”). As shown in FIG. 1, program system 32 includes clock system 34, alarm system 36, snooze system 38, volume system 40, type selection system 42, harmonic system 43, motion detection system 44, time system 46, and limit system 48.

User 22 will initially program alarm clock 10 by setting the time via clock system 34 and designating an alarm time via alarm system 36. Under the present invention, user 22 can then designate distinct alarm signals 28. In a typical embodiment, user 22 will designate distinct alarm signals 28 based upon volume level, alarm type and/or alarm signal harmonics.

Volume system 40 allows user 22 to designate volume levels for each alarm signal 28. For example, user 22 can designate a first volume level for a first alarm signal 28 and a second higher volume level for a second alarm signal 28, both of which can be stored in database 20. When the initial alarm time is reached, controller 14 (in conjunction with volume system 40) will access database 20 to ensure that the first alarm signal 28 is produced by the speaker at the first designated volume level. Then, if user 22 activates snooze mechanism 26, controller 14 will ensure that the second alarm signal 28 is produced at the second distinct (e.g., higher) designated volume level (i.e., after the snooze time has elapsed). It should be understood that the precise manner in which an alarm signal 28 is snoozed when user 22 activates snooze mechanism 26 is well known in the art and is not intended to be a limiting part of the present invention. The present invention is concerned with the designation and production of distinct alarm signals 28 in conjunction with the snooze feature.

Under the present invention, user 22 can designate as many distinct alarm signals 28 as desired so that he/she cannot become immune to the alarm signal volume and/or will not subconsciously activate snooze mechanism 26 without awaking. Although user will typically designate distinct (e.g., higher) volume levels for successive alarm signals 28, this need not be the case. Specifically, user 22 can designate any volume level for any alarm signal 28. For example, user 22 could designate same volume level for two or more successive alarm signals 28. In any event, all designated volume levels could be stored in database 20 and accessed by controller 14 to ensure that the proper volume level is produced with its corresponding alarm signal 28.

Type selection system 42 allows user 22 to designate alarm signals 28 based upon alarm type. Currently, many alarm clocks are equipped with the capability to produce a buzzer or a radio alarm type. The present invention allows user 22 to vary the alarm type for different alarm signals 28. For example, the user may designate the first alarm signal 28 as the radio, while designating the second alarm signal 28 as the buzzer. When the alarm time is reached, controller 14 (in conjunction with type selection system 42) will ensure that the first alarm signal 28 is produced from the radio and the second alarm signal 28 is produced from the buzzer. Under the present invention, any known alarm signal type can be designated. For example, user 22 could designate a buzzer, an audio (i.e., radio, compact disk, etc.), or a visual (e.g., light sequence) alarm signal type depending on the features 50 of alarm clock 10.

It should be understood that, similar to volume level, user 22 can designate any alarm type for any alarm signal 28. For example, user 22 could designate the same alarm type for two or more successive alarm signals 28. Moreover, similar to volume levels, any designated alarm types could be stored in database 20 and accessed by controller 14 (in conjunction with type selection system 42) to ensure that the proper alarm type is produced with its corresponding alarm signal 28. It should also be appreciated that the designation of distinct alarm types could be done alone or in conjunction with volume levels. For example, user 22 could designate the first alarm signal 28 to be the buzzer at a first volume level, and the second alarm signal 28 to be the radio at a second higher volume level.

Harmonic system 43 allows user 22 to designate distinct alarm signals 28 based upon alarm signal harmonics. For example, user 22 may wish to designate a first pitch for a first alarm signal 28 and a second pitch for a second alarm signal 28. Thus, similar to designation of volume levels and alarm types, when the alarm time is reached, controller will ensure that the first alarm signal 28 is produced at the first designated pitch and the second alarm signal 28 is produced at the second designated pitch. It should be understood that any known type of harmonics could be designated by user 22 to create distinct alarm signals 28. For example, user could designate distinct alarm signal frequencies.

It should also be understood that user 22 could designate any harmonic for any alarm signal 28. For example, user 22 could designate the same pitch for two or more successive alarm signals 28. Moreover, similar to volume levels and alarm types, any designated alarm signal harmonics could be stored in database 20 and accessed by controller 14 (in conjunction with harmonic system 43) to ensure that the proper alarm signal harmonic is produced with its corresponding alarm signal 28. It should also be appreciated that the designation of distinct alarm signal harmonics could be done alone or in conjunction with volume levels and/or alarm types. For example, user 22 could designate the first alarm signal 28 to be the buzzer at a first volume level and a first frequency, and the second alarm signal 28 to be the radio at a second higher volume level and a second higher frequency.

Time system 46 allows user 22 to designate the snooze time between each alarm signal 28. As known in the art, current alarm clocks are preprogrammed with a fixed period of time between alarm signals (e.g., ten minutes) when the snooze mechanism is activated. Under the present invention, user 22 can designate this snooze time. In accordance with this feature, user 22 can either designate the same snooze time between all alarm signals 28, or a distinct snooze time between two or more alarm signals 28. For example, user 22 could designate a snooze time of ten minutes between all alarm signals 28. Alternatively, user 22 could designate the snooze time between the first alarm signal 28 and the second alarm signal 28 as ten minutes, while designating the snooze time between the second alarm signal 28 and a third alarm signal 28 as five minutes. This capability helps prevent user 22 from wasting unnecessary amounts of time using the snooze feature of alarm clock 10. In any event, controller 14 will ensure (in conjunction with time system 46) that the proper snooze time is used between the alarm signals 28. Moreover, it should be understood that the designation of snooze time between alarm signals 28 can be done alone or in any combination with the designation of alarm signal type, alarm signal volume level and/or alarm signal harmonics. For example, user 22 could program alarm clock 10 so that: (1) the first alarm signal 28 is the buzzer at a first volume level; (2) the second alarm signal 28 occurs through the radio at a second higher volume level ten minutes after snoozing the first alarm signal 28; (3) and the third alarm signal 28 occurs through the CD player at a third highest volume five minutes after snoozing the second alarm signal 28. In addition, similar to volume levels and alarm types, all designated snooze times can be stored in database 20 and accessed by controller 14 (in conjunction with time system 46) to ensure that the proper snooze time is used between the alarm signals 28.

Limit system 48 allows user 22 to designate a maximum snooze quantity. As indicated above, many individuals activate the snooze mechanism multiple times. Often, such activation is done subconsciously so that the individual is not aware he/she is doing so and accordingly, is not awakened by the alarm signal 28. By designating a maximum snooze quantity, an alarm signal 28 will not be snoozed if the designated quantity has been matched. For example if user 22 designates a maximum snooze quantity of two, controller 14 will ensure that the third alarm signal 28 continues even if user 22 attempts to activate snooze mechanism 26. Similar to the other features of alarm clock 10, the designation of a maximum snooze quantity can be used alone or in conjunction with designated volume levels, alarm types and/or snooze times. Moreover, similar to volume levels, alarm types, alarm signal harmonics and/or snooze times, a designated maximum snooze quantity could be stored in database 20 and accessed by controller 14 (in conjunction with limit system 48) to ensure that the maximum snooze limit is applied to the alarm signals 28.

Motion detection system 44 allows user to designate a motion detection period. If no motion is detected proximate alarm clock 10 during the designated period, alarm clock 10 will be disengaged. Specifically, the lack of motion around alarm clock 10 during the designated period will result in the alarm function being disabled so that no alarm signals 28 will be produced. This feature is especially useful when user 22 is at a location different from that of alarm clock 10. For example, user 22 could designate the motion detection period to be fifteen hours. If no motion was detected during this period, the alarm clock 10 would be disengaged. Thus, if user 22 went out of town and forgot to manually disengage alarm clock 10, controller 14 (in conjunction with motion detection system 44) would automatically disengage alarm clock 10 if no motion was detected proximate clock 10 (e.g., within user's bedroom) during the designated period. This would prevent alarm signals 28 from being produced until user 22 manually re-engages alarm clock 10 (i.e., reset the alarm). Similar to other features of alarm clock 10, designation of a motion detection period can be used alone or in conjunction with designation of volume levels, alarm types, snooze times, and/or maximum snooze quantity. Moreover, similar to volume levels, alarm types, alarm signal harmonics, snooze times, and/or maximum snooze quantity, a designated motion detection period could be stored in database 20 and accessed by controller 14 (in conjunction with motion detection system 44) to ensure that the proper motion detection period is applied.

To detect motion proximate alarm clock 10, motion detector 30 is provided. Preferably, motion detector 30 is positionable by user 22 so that it can be placed in the best position for detecting motion. This allows motion to be detected regardless of room configuration and/or sleeping arrangement. Moreover, a positionable motion detector 30 would allow user 22 to focus the detector 30 on, for example, his/her bed to detect sleeping motion so that alarm clock 10 is not inadvertently disengaged while user 22 is sleeping.

It should be understood that program system 32 as depicted in FIG. 1 is intended to be illustrative only and other variations could exist. For example, time system 46 and limit system 48 could be shown as separate systems instead of part of snooze system 38. Moreover, as explained above, two or more successive alarm signals 28 can be distinctly designated or similarly designated. For example, a first alarm signal 28 could have the same designated volume level as a second alarm signal 28, while a third alarm signal 28 could have a higher designated volume level. This provides user 22 with optimal flexibility in designating distinct alarm signals 28.

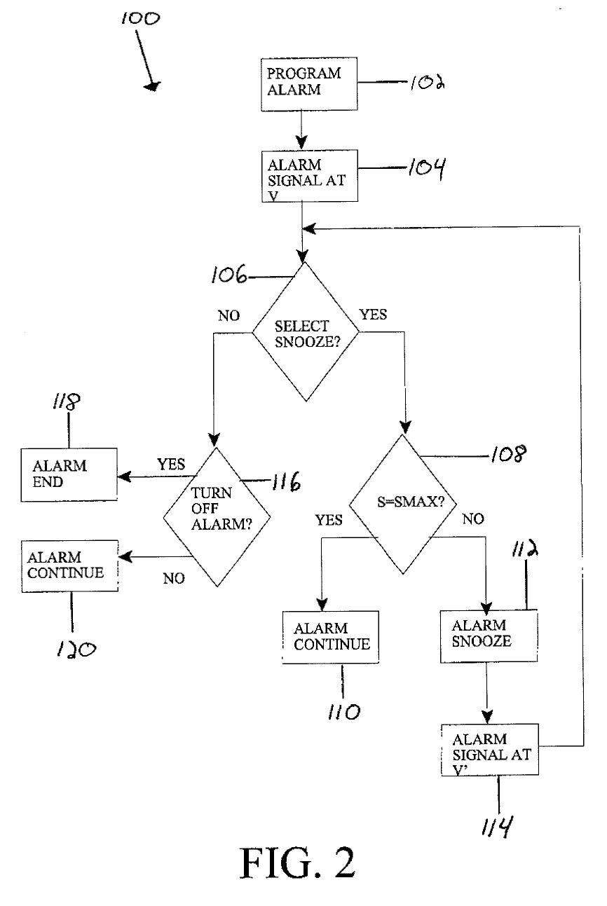

Referring now to FIG. 2, a flowchart 100 of one embodiment of the present invention is shown. As described above, user 22 would program alarm clock 102 as desired. This could include setting the time and designating an alarm time, volume levels, alarm types, alarm signal harmonics, snooze times, a snooze quantity maximum, and/or a motion detection period. For the purposes of the example shown in FIG. 2, it will be assumed that user 22 has designated distinct alarm signals 28 based upon volume level. This is so that when a first alarm signal 28 being produced at a first volume level is deactivated (i.e., snooze mechanism 26 is activated), a second alarm signal 28 will be produced at a second (higher or lower) volume level after the snooze time. Irrespective of this example, it should be appreciated that user 22 could designate any volume level (e.g., including identical volume levels) for any alarm signal 28.

When the first alarm signal 28 is produced 104 at the designated alarm time and at the first designated volume level V, the user 22 can select whether to snooze the alarm 106 (i.e., by activating mechanism 26). If user 22 selected to snooze the first alarm signal 28, it would be determined whether user 22 has already matched the maximum snooze quantity 108 (if designated). For example, if user 22 designated a maximum snooze quantity of two, and user 22 had already activated snooze mechanism 26 two times, the current alarm signal 28 would continue 110 irrespective of user's 22 attempt to activate snooze mechanism 26 a third time. Alternatively, if user 22 has either not designated a maximum snooze quantity or has not matched the designated quantity, the alarm signal 28 would snooze (discontinue) 112. Once discontinued, a new alarm signal 28 would be produced at the second designated volume level 114 V′ after the snooze time. As indicated above, it should be understood that the snooze time could be designated by user 22 or could be a default snooze time preprogrammed into alarm clock 10. Moreover, it should be appreciated that similar to volume level designation, user 22 could designate the same snooze time between all alarm signals 28, or different snooze times between two or more alarm signals 28. Once the new alarm signal 28 is produced at the higher volume level V′ 114, the user can repeat steps 106-114 based upon the programming of alarm clock 10. If at step 106, user 22 chooses not to snooze an alarm signal 28, it will be determined whether user 22 has manually turned off (disengaged) the alarm 116. If user 22 has done so, the alarm signal 28 will end 118. If not, the alarm signal 28 will continue 120.

As indicated above, alarm clock 10 can be realized as a standard alarm clock or as a computer-based alarm clock. Accordingly, it is understood that the present invention can be realized in hardware, software, or a combination of hardware and software. Moreover, alarm clock 10 according to the present invention can be realized in a centralized fashion in a single computerized system, or in a distributed fashion where different elements are spread across several interconnected systems as shown in FIG. 1 (e.g., a network). Any kind of computer system(s)—or other apparatus adapted for carrying out the methods described herein—is suited. A typical combination of hardware and software could be a general purpose computer system with a computer program that, when loaded and executed, controls alarm clock 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the embodiment of alarm clock 10 shown in FIG. 1 is for exemplary purposes only. It should be understood that alarm clock 10 could also be realized as a processor and a programmable controller in lieu of program system 32 residing in memory 18 as shown.

1. An interactive alarm clock comprising:
a system for designating distinct alarm signals; and
a snooze mechanism for deactivating a first designated alarm signal and automatically activating a second designated alarm signal after a predetermined time.

2. The alarm clock of claim 1, wherein each successive activation of the snooze mechanism results in a new designated alarm signal.

3. The alarm clock of claim 1, wherein the system for designating distinct alarm signals comprises a volume system for designating volume levels for the alarm signals, and wherein the first alarm signal has a different volume level than the second alarm signal.

4. The alarm clock of claim 1, wherein the system for designating distinct alarm signals comprises a type selection system for designating alarm types for the alarm signals, and wherein the first alarm signal is a different alarm type than the second alarm signal.

5. The alarm clock of claim 4, wherein the alarm type is selected from the group consisting of audio, buzzer and visual.

6. The system of claim 1, wherein the system for designating distinct alarm signals comprises a harmonic system for designating alarm signal harmonics for the alarm signals, and wherein the first alarm signal has different alarm signal harmonics than the second alarm signal.

7. The alarm clock of claim 1, further comprising a time system for designating the predetermined time.

8. The alarm clock of claim 1, further comprising a motion detection system for designating a motion detection period, wherein the alarm clock is disengaged if no motion is detected proximate the alarm clock during the motion detection period.

9. The alarm clock of claim 8, further comprising a positionable motion detector for detecting motion proximate the alarm clock.

10. The alarm clock of claim 1, further comprising a limit system for designating a maximum snooze quantity, wherein the first alarm signal will not be deactivated if the maximum snooze quantity is matched.

11. An interactive alarm clock, comprising:
a volume system for designating distinct volume levels for successive alarm signals; and
a snooze mechanism for deactivating a first alarm signal having a first designated volume level and automatically activating a second alarm signal having a second designated volume level after a predetermined time.

12. The alarm clock of claim 11, wherein each successive activation of the snooze mechanism results in a new alarm signal having a higher designated volume level.

13. The alarm clock of claim 11, further comprising,
a time system for designating the predetermined time;
a limit system for designating a maximum snooze quantity;
a type selection system for designating an alarm type;
a harmonic system for designating alarm signal harmonics; and
a motion detection system for designating a motion detection period,
wherein the alarm clock is disengaged if no motion is detected proximate the alarm clock during the motion detection period.

14. The alarm clock of claim 13, further comprising a positionable motion detector for detecting motion proximate the alarm clock.

15. A method for operating an alarm clock, comprising:
designating distinct alarm signals; and
deactivating a first designated alarm signal and automatically activating a second designated alarm signal after a predetermined time.

16. The method of claim 15, wherein the first alarm signal has a different volume level than the second alarm signal.

17. The method of claim 15, wherein the first alarm signal is a different alarm type than the second alarm signal.

18. The method of claim 15, wherein the first alarm signal has different alarm signal harmonics than the second alarm signal.

19. The method of claim 15, further comprising:
designating the predetermined time;
designating a maximum snooze quantity, wherein the first alarm signal will not be deactivated if the maximum snooze quantity is matched; and
designating a motion detection period and disengaging the alarm clock if no motion is detected proximate the alarm clock during the designated period.

20. A program product stored on a recordable medium for programming an alarm clock, comprises:
program code for designating distinct alarm signals; and
program code for deactivating a first designated alarm signal and automatically activating a second designated alarm signal after a predetermined time.

21. The program product of claim 20, wherein the program code for designating distinct alarm signals comprises program code for designating distinct volume levels for the alarm signals.

22. The program product of claim 20, wherein the program code for designating distinct alarm signals comprises program code for designating distinct alarm types for the alarm signals.

23. The program product of claim 20, wherein the program code for designating distinct alarm signals comprises program code for designating distinct alarm signal harmonics for the alarm signals.
